(19) United States
(12) Patent Application Publication
(10) Pub. No.: US 2019/0005891 A1
(43) Pub. Date: Jan. 3, 2019

(54) ELECTROPHORETIC DISPLAY DEVICE WITH ANTI-REFLECTIVE NANOPARTICLES

(71) Applicant: HEWLETT-PACKARD DEVELOPMENT COMPANY, L.P., Houston, TX (US)

(72) Inventors: Kuan-Ting WU, Taichung (TW); Wei Kuang CHU, Taipei City (TW); Wei-Chung CHEN, Taipei City (TW); Cheng-Hua YU, Taipei City (TW)

(21) Appl. No.: 15/748,650

(22) PCT Filed: Dec. 4, 2015
(86) PCT No.: PCT/US2015/064054

§ 371 Date: Jan. 29, 2018

(51) Int. Cl. G09G 3/34; G02F 1/167; G06F 3/041

(52) U.S. Cl. CPC G09G 3/344; G02F 1/167; G06F 3/041; G02F 2001/1678; G09G 2300/023; G09G 2358/00; G09G 2320/0606; G09G 2320/0626; G09G 2320/066; G09G 2354/00

(57) ABSTRACT

Example implementations relate to an electrophoretic display (EPD) device with anti-reflective nanoparticles. For example, a display device may include a display panel to display content and an EPD device adjacent to the display panel. The EPD device provides a voltage to at least a portion of the EPD device such that positively-charged anti-reflective nanoparticles in the EPD device are moved toward a negative voltage and negatively-charged anti-reflective nanoparticles in the EPD device are moved toward a positive voltage. The content is displayed based on locations of the positively-charged anti-reflective nanoparticles and the negatively-charged anti-reflective nanoparticles in response to the voltage.

### BACKGROUND

A computing device may include and/or may be in communication with a display device that allows a user to view content. Some display devices may be a touch screen display device that allows a user to provide touch inputs. For example, a user may use their finger and/or a stylus pen to provide touch inputs on the screen in order to manipulate the content on the screen.

### BRIEF DESCRIPTION OF THE DRAWINGS

Some examples of the present application are described with respect o the following figures:

FIG. 1 is a block diagram of example electrophoretic display device cross-sections that are controlled based on settings;

FIG. 2 is a block diagram of an example display device that has an electrophoretic display device;

FIG. 3 is a block diagram of an example computing device that is controlled based on user-specified settings; and

FIG. 4 is a block diagram of an example touch screen display device that is controlled based on user-specified settings.

### DETAILED DESCRIPTION

As described above, a computing device may include and/or may be in communication with a display device that allows a user to view content, Examples of these devices include smartphones, tablets, laptops, monitors, and the like. Because the use of such devices has become prevalent, protecting a user's privacy while using these devices has become a concern. Additionally, prolonged use of these display devices may cause health issues for a user, such as discomfort to the user's eyes, eye damage and/or disease, premature aging of the eye, and the like.

Examples discussed herein provide techniques for providing privacy, brightness and contrast controls, and/or ultraviolet (UV) and/or blue light absorption on a display device having an electrophoretic display (EPD) device. An EPD device may have microcapsules filled with a suspension of charged anti-reflective nanoparticles, where the microcapsules are located between two parallel conducting electrode panels that may provide a voltage such that at least a portion of the charged particles move in a particular direction based on the voltage. The voltage may be applied such that the charged particles move in a particular direction in order to display and/or block content, provide brightness and/or contrast controls, and/or reduce UV/blue light emissions.

The display device may control its EPD device based on user-specified settings, For example, a user-specified setting may specify a manner of making at least a portion of the display private, and the EPD device of the display device may apply a voltage to areas of the EPD device according to the settings such that the portion of the display is made private. A user-specified setting may also specify a manner of setting the brightness and/or contrast for at least a portion of the display, and the EPD device of the display device may apply a voltage to areas of the EPD device according to the settings such that the brightness and/or contrast is adjusted accordingly for the portion of the display. A user-specified setting may also specify a manner of reducing UV/blue light emissions for at least a portion of the display, and the EPD device of the display device may apply a voltage to areas of the EPD device according to the settings such that UV/blue light emission is reduced for the portion of the display.

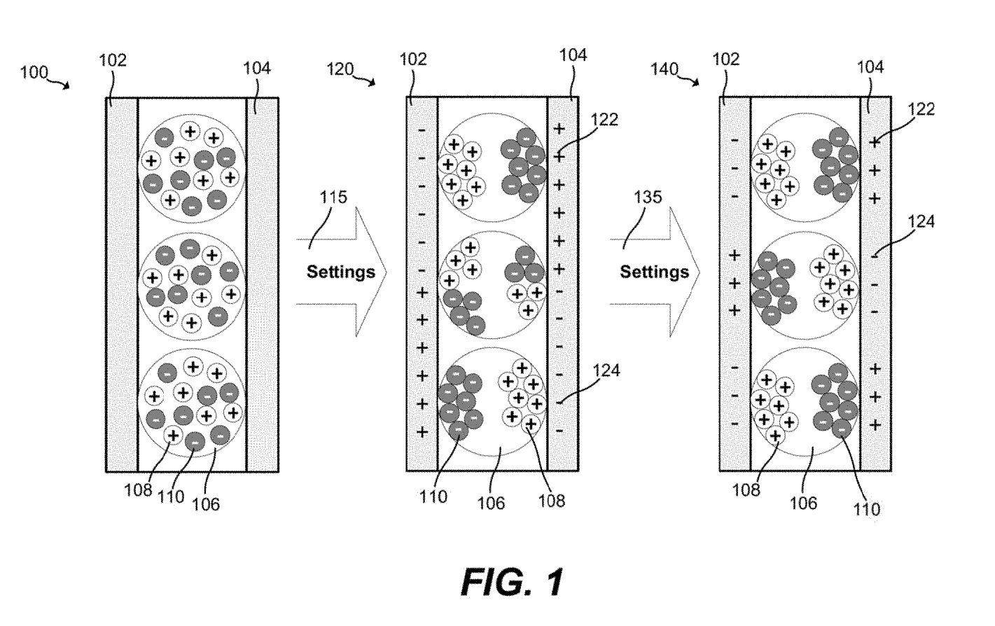

Referring now to the figures, FIG. 1 is a block diagram of example EPD device cross-sections 100, 120, and 140 that are controlled based on settings, such as settings 115 and 135. The EPD device cross-sections 100, 120, and 140 may be cross-sections of an EPD device in a display device that may manage privacy, brightness and/or contrast, and UV/blue light emissions based on settings. The EPD device cross-sections 100, 120, and 140 may include a first electrode panel 102, a sec electrode panel 104, a microcapsule 106, a positively-charged anti-reflective nanoparticle 108, and negatively-charged anti-reflective nanoparticle 110.

The first electrode panel 102 and the second electrode panel 104 may be any suitable electrically-conductive material capable of providing a voltage at particular portions of each panel. In some examples, the first electrode panel 102 may the electrode panel closest to a user viewing content on the display device, and as such, the first electrode panel 102 may transmit a relatively high percentage of light such that the first electrode panel 102 is transparent and/or at least semi-transparent, allowing content to be displayed through the first electrode panel 102. The first electrode panel 102 and the second electrode panel 104 may each be a conductor used to apply voltage within the EPD device cross-sections 100, 120, and 140.

The microcapsule 106 may be any suitable microcapsule to hold any suitable number of ant-reflective nanoparticles, such as the positively-charged anti-reflective nanoparticle 108 and the negatively-charged anti-reflective nanoparticle 110. In addition to the anti-reflective nanoparticles, the microcapsule 106 may include a clear fluid through which the anti-reflective nanoparticles may move (e.g., in response to a voltage applied at the first electrode panel 102 and/or the second electrode panel 104).

The positively-charged anti-reflective nanoparticle 108 and the negatively-charged anti-reflective nanoparticle 110 may be any suitable type of anti-reflective nanoparticle used to provide privacy, a particular brightness and/or contrast level, and/or UV/blue light reduction. The positively-charged anti-reflective nanoparticle 108 and the negatively-charged anti-reflective nanoparticle 110 may each be any suitable type of anti-reflective nanopaticle, such as a semi-transparent or opaque anti-reflective nanoparticle (e.g., anti-reflective nanoparticle with 10-90% transmittance), a white or black charged anti-reflective nanoparticle, and the like. For example, the positively-charged anti-reflective nanoparticle 108 may be a white or transparent nanoparticle to allow content to be displayed, and the negatively-charged anti-reflective nanoparticle 110 may be a black or opaque nanoparticle to block content from being displayed. In some examples, the positively-charged anti-reflective nanoparticle 108 and the negatively-charged anti-reflective nanoparticle 11 may be a yellow nanoparticle to reduce UViblue light emission. Examples of anti-reflective nanoparticles include nanoparticles formed from materials such as silver, palladium, ruthenium, rhodium, gold and platinum, SiO₂, MgF₂, SnO₂, SnO₂+Sb₂O₃, In₂O₃, In₂O₃+SnO₂, TiO₂, ZrO₂, metal oxide, a metal fluoride, fumed silica, polymer particles, hollow transparent ceramics (e.g., silica, borosilicate glass, soda-lime glass, etc.), hollow transparent resins, and the like.

The EPD device cross-section 100 shows the distribution of positively-charged anti-reflective nanoparticle 108 and the negatively-charged anti-reflective nanopaticle 110 in the microcapsule 106 when no voltage is applied at the first electrode panel 102 and the second electrode panel 104 (e.g., based on user-specified settings or based on a default setting). The positively-charged anti-reflective nanoparticle 108 and the negatively-charged anti-reflective nanoparticle 110 are distributed at various locations within the microcapsule 106, as there is no charge moving the positively-charged anti-reflective nanoparticle 108 and/or the negatively-charged anti-reflective nanoparticle 110 toward a particular voltage.

The EPD device cross-section 120 shows the distribution of positively-charged anti-reflective nanoparticle 108 and the negatively-charged anti-reflective nanoparticle 110 in the microcapsule 106 when a positive voltage 122 and a negative voltage 124 are applied at various locations of the first electrode panel 102 and the second electrode panel 104 based on the settings 115, For example, the settings 115 may indicate that content displayed at a particular portion of the display is to be at least partially blocked, and voltage may be applied accordingly such that the positively-changed anti-reflective nanoparticles 108 (e.g., white, transparent, or semi-transparent nanoparticles) move toward the negative voltage 124 and the negatively-charged anti-reflective nanoparticle 110 (e.g., black or opaque nanoparticles) move toward the positive voltage 122. Similarly, the settings 115 may indicate a particular brightnesslcontrast level or a particular reduction in UV/blue light emission for at least a portion of the display, and voltage may be applied accordingly such that the positively-charged anti-reflective nanoparticles 106 (e.g., white, transparent, or semi-transparent nanoparticles) move toward the negative voltage 124 and the negatively-charged anti-reflective nanoparticle 110 (e.g., black, opaque, or yellow nanoparticles) move toward the positive voltage 122.

The EPD device cross-section 140 shows the distribution of positively-charged anti-reflective nanoparticle 108 and the negatively-charged anti-reflective nano article 110 in the microcapsule 106 when a positive voltage 122 and a negative voltage 124 are applied at different locations of the first electrode panel 102 and the second electrode panel 104 based on the settings 135. For example, a modification to the settings may be detected (e.g., a change from, settings 115 to settings 135), and the voltage applied to the first electrode panel 102 and the second electrode panel 104 may be adjusted based on the modification. As the EPD device cross-section 140 shows, the voltage may be applied at selective areas according to the settings 135 such that the positively-charged anti-reflective nanoparticles 108 (e.g., white, transparent, or semi-transparent nanoparticles) move toward the negative voltage 124 and the negatively-charged anti-reflective nanoparticle 110 (e.g., black or opaque nanoparticles) move toward the positive voltage 122.

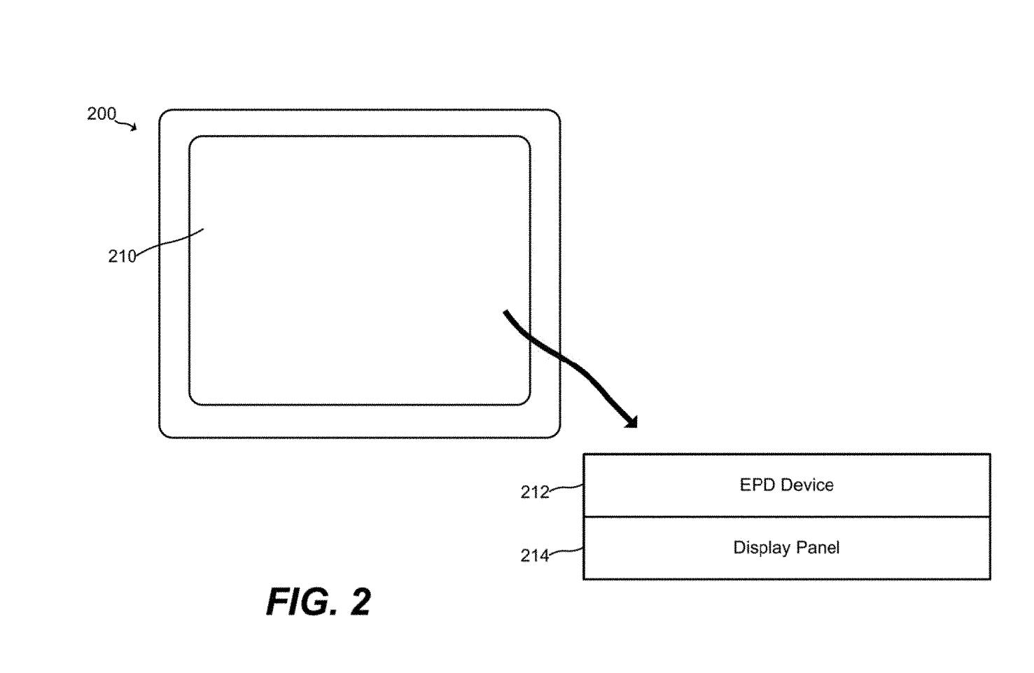

FIG. 2 is a block diagram of an example display device 200 that has an EPD device 212. The display device 200 may be any suitable computing device having a display, such as a notebook computer, a desktop monitor, a tablet computing device, a mobile phone, an electronic book reader, a display on a printing device, or any other suitable electronic display device capable of displaying content. The display device 200 may include a display component 210 to display various content on the display device 200 (e.g., using a processor(s) of the display device 200 and/or a processor(s) in communication with the display device 200).

The display component 210 may include an EPD device 2 and a display panel 214 adjacent (e.g., next to, touching, etc.) to the EPD device 212. The display panel 214 may be any suitable electronic component(s) to display content. For example, the display panel 214 may display content based on an input (e.g., touch input) received by the display device 200. 1n some examples, the display panel 214 may include an in-cell touch screen sensor to receive touch inputs, or the display component 210 may include a touch screen sensor to receive touch inputs. The display panel 214 may be any suitable type of display panel, such as a liquid crystal display (LCD), an organic light emitting diode (OLED) display, a polymer light emitting diode (PLED) display, a plasma display, bi-stable display (e.g., a cholesteric display, a cholesteric LCD, a micro-electromechanical system (MEMS)-based display, etc.), and the like.

The EPD device 212 may be any suitable type of EPD device having any suitable type of charged (e.g., negatively-charged or positively-charged) anti-reflective nanoparticle (e.g., opaque, semi-transparent, anti-reflective, yellow, black, and/or white anti-reflective nanoparticle), where the location of the anti-reflective nanoparticle may be based on applied voltage. The EPD device 212 may have two parallel conducting electrode panels to apply the voltage, such as the first electrode panel 102 and the second electrode panel 104 shown in FIG. 1. For example, the EPD device 212 may provide a voltage to at least a portion of the EPD device 212 such that positively-charged anti-reflective nanoparticles in the EPD device are moved toward a negative voltage and negatively-charged anti-reflective nanoparticles in the EPD device are moved toward a positive voltage. This may allow the content displayed by display panel 214 to be displayed based on locations of the positively-charged anti-reflective nanoparticles and, the negatively-charged anti-reflective nanoparticles in response to the voltage.

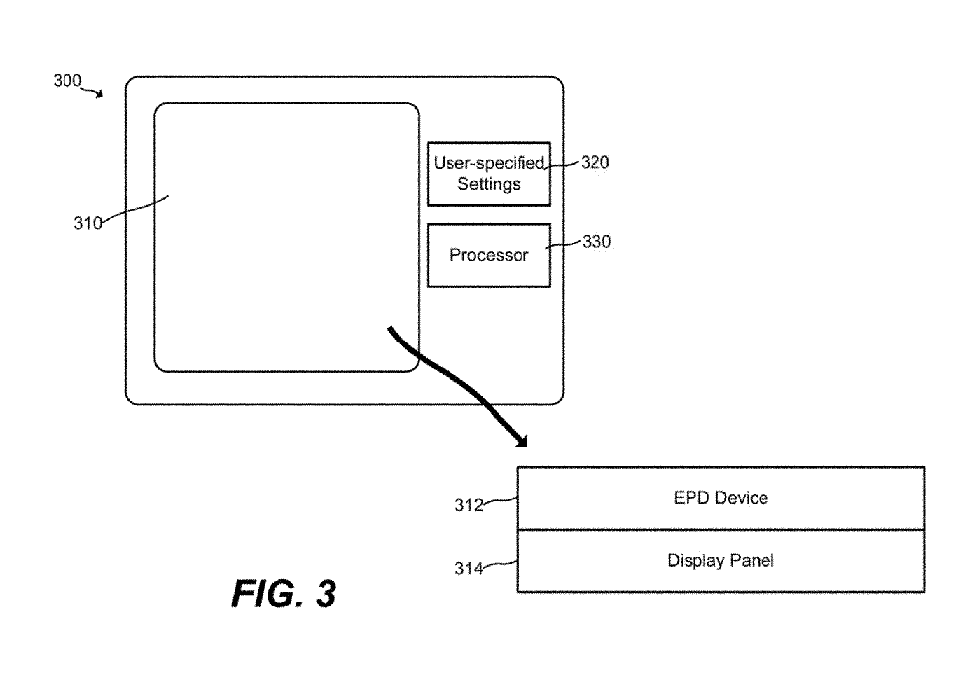

FIG. 3 is a block diagram of an example computing device 300 that is controlled based on user-specified settings 320. The computing device 300 may be similar to the display device 200 of FIG. 2 and may include a display component 310, which may be similar to the display component 210 of FIG. 2, user-specified settings 320 (e.g., stored in a memory device of the computing device 300), and a processor 330.

The display component 310 may include an EPD device 312 and a display panel 314 adjacent to the EPD device 312. The display panel 314 may be similar to the display panel 214 of FIG. 2 and may display content. The EPD device 312 may be similar to the EPD device 212 of FIG. 2 and may be adjacent to the display panel 314.

Processor 330 is a tangible hardware component that may be a central processing unit (CPU), a semiconductor-based microprocessor, and/or other hardware devices suitable for retrieval and execution of instructions stored in a machine-readable storage medium. Processor 300 may fetch, decode, and execute any instructions to control a process of displaying content on the computing device 300 based on the user-specified settings 320. As an alternative or in addition to retrieving and executing instructions. processor 330 may include at least one electronic circuit that includes electronic components for performing the functionality of the instructions. For example, the processor 330 may be any suitable processor(s) in communication with the EPD device 312 and may identify the user-specified settings 320, and, based on the user-specified settings 320, may apply a voltage to at least a portion of the EPD device 312 such that positively-charged anti-reflective nanoparticles in the EPD device are moved toward a negative voltage and negatively-charged anti-reflective nanoparticles in the EPD device are moved toward a positive voltage. The content displayed by the display panel 314 may be displayed based on locations of the positively-charged anti-reflective nanoparticles and the negatively-charged anti-reflective nanoparticles in response to the voltage. For example, the user-specified settings 320 may specify a privacy setting, a brightness/contrast setting, and/or a UV/blue light reduction setting, and the voltage may be applied such that the positively-charged anti-reflective nanoparticles and the negatively-charged anti-reflective nanoparticles are moved to locations that allow the content to be displayed, and/or blocked according to the user-specified settings 320.

The voltage may be applied based on the user-specified settings 320. In some examples, the user-specified settings 320 may include a privacy setting, and a voltage may be applied such that either the positively-charged anti-reflective nanoparticles or the negatively-charged anti-reflective nanoparticles in the EPD device 312 at least partially block the content displayed by display panel 314 according to the privacy setting. In this example, the anti-reflective nanoparticles that block the content may be opaque anti-reflective nanoparticles, semi-transparentanti-reflective; nanoparticles, or black anti-reflective nanoparticles.

In some examples, the user-specified settings 320 may include a brightness or contrast setting, and a voltage may be applied such that the content displayed by display panel 314 is displayed based on the bnghtness or contrast setting,

In some examples, the user-specified settings 320 may include a UV/blue light reduction setting, and a voltage may be provided such that either the positively-charged anti-reflective nanoparticles or the negatively-charged anti-reflective nanoparticles in the EPD device 312 at least partially blocks UV/blue light emitted from the content displayed by display panel 314 according to the UV/blue light reduction setting.

me examples, a user may select the degree of privacy, brightness/contrast, and/or UV/blue light reduction using the user-specified settings 320, and a voltage may be applied in a particular amount andlor at a particular location(s) according to the user-specified settings 320. For example, the user-specified settings 320 may specify a viewing area and a non-viewing area of the display device 300, and a voltage may be provided in the viewing area such that either the positively-charged anti-reflective nanoparticles or the negatively-charged anti-reflective nanoparticles in the EPD device 312 at least partially blocks the content in the non-viewing area or at least partially adjusts brightness/contrast in the non-viewing area.

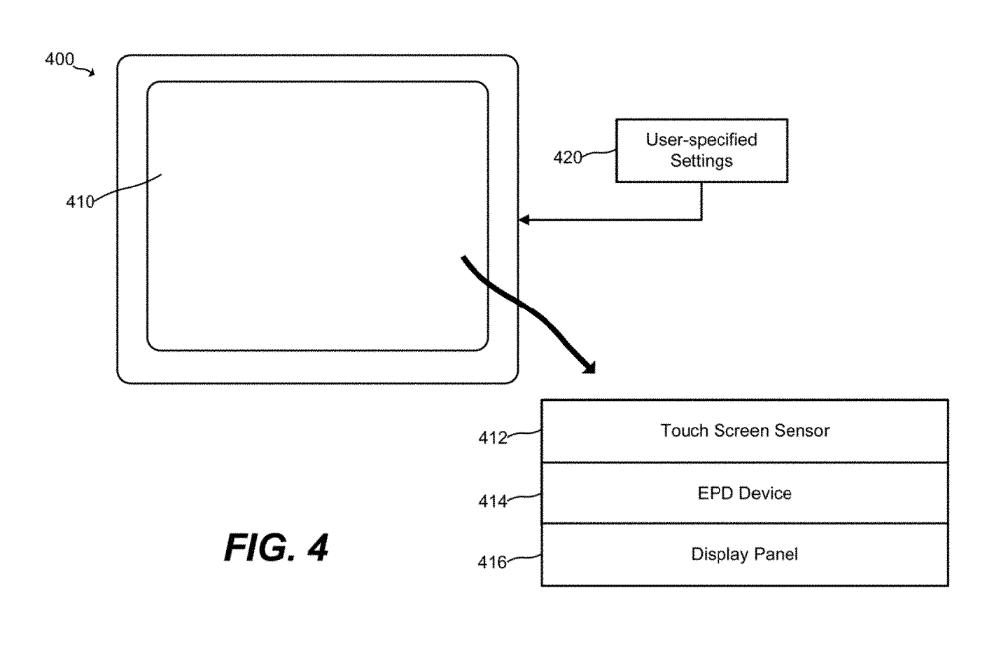

FIG. 4 is a block diagram of an example touch screen display device 400 that is controlled based on user-specified settings 420. The touch screen display device 400 may be similar to the display device 200 of FIG. 2 and may include a display component 410, which may be similar to the display component 210 of FIG. 2.

The display component 410 may include a touch screen sensor 412, an EPD device 414, and a display panel 416. The touch screen sensor 412 may be any suitable sensor to detect and/or process touch inputs. For example, the touch screen sensor 412 may receive a touch input (e.g., from a user).

The display panel 416 may be similar the display panel 214 of FIG. 2 and may display content. For example, the display panel 416 may display content based on the touch input received by the touch screen sensor 412.

The EPD device 414 may be similar to e EPD device 212 of FIG. 2 and may be adjacent to and/or between the touch screen sensor 412 and the display panel 416 The EPD device 414 may, based on the user-specified settings 420, provide a voltage to at least a portion of the EPD device 414 such that positively-charged anti-reflective nanoparticles in the EPD device are moved toward a negative voltage and negatively-charged anti-reflective nanoparticles in the EPD device are moved toward a positive voltage. The content displayed by display panel 416 may be displayed based on locations of the positively-charged anti-reflective nanoparticles and the negatively-charged anti-reflective nanoparticles in response to the voltage. For example, the user-specified settings 420 may specify a privacy setting, a brightness/contrast setting, and/or a UV/blue light reduction setting, and the voltage may be provided such that the positively-charged anti-reflective nanoparticles and the negatively-charged anti-reflective nanoparticles are moved to locations that allow the content to be displayed and/or blocked according to the user-specified settings 420.

What is claimed is:

1. A display device, comprising:
a display panel to display content; and
an electrophoretic display (EPD) device adjacent to the display panel, the EPD device to provide voltage to at least a portion of the EPD device such that positively-charged anti-reflective nanopaticles in the EPD device are moved toward a negative voltage and negatively-charged anti-reflective nanoparticles in the EPD device are moved toward a positive voltage, ,wherein, the content is displayed based on locations of the positively-charged anti reflective nanoparticles and the negatively-charged anti-reflective nanopaticles in response to the voltage.

2. The display device of claim 1, wherein the voltage is provided based on a user-specified privacy setting such that the positively-charged anti-reflective nanoparticles or the negatively-charged anti-reflective nanoparticles at least partially block the content according to the user-specified privacy setting.

3. The display device of claim 1, wherein the voltage is provided based on a user-specified brightness or contrast setting such that the content is displayed based on the brightness or contrast setting.

4. The display device of claim wherein the voltage is provided based on a user-specified light reduction setting such that the positively-charged anti-reflective nanoparticles or the negatively-charged anti-reflective nanoparticles at least partially block ultraviolet or blue light according to the user-specified light reduction setting.

5. The display device of claim 1, wherein the positively-charged anti-reflective nanoparticles are black nanoparticles and the negatively-charged anti-reflective nanoparticles are white nanoparticles, or wherein the positively-charged anti-reflective nanoparticles are white nanoparticles and the negatively-charged anti-reflective nanoparticles are black nanoparticles.

6. The display device of claim 1, wherein the voltage is provided based on a user-specified privacy setting that specifies a viewing area and a non-viewing area of the display device such that the positively-charged anti-reflective nanoparticles or the negatively-charged anti-reflective nanoparticles at least partially block the content in the non-viewing area.

7. The display device of claim 1, wherein the positively-charged anti-reflective nanoparticles and the negatively-charged anti-reflective nanoparticles are located between a first electrode panel and a second electrode panel of the EPD device and wherein the voltage is provided to the first electrode panel and the second electrode panel.

8. A computing device, comprising:
a display panel to display content;
an electrophoretic display (EPD) device adjacent to the display panel; and
a processor in communication with the EPD device, the process to:
identify user-specified settings; and
based on the user-specified settings, apply a voltage to at least a portion of the EPD device such that positively-charged anti-reflective nanoparticles in the EPD device are moved toward a negative voltage and negatively-charged anti-reflective nanoparticles in the EPD device are moved toward a positive voltage, wherein the content is displayed based on locations of, the positively-charged anti-reflective nanoparticles and the negatively-charged anti-reflective nanoparticles in response to the voltage.

9. The computing device of claim 8, wherein the user-specified settings include a privacy setting and wherein the voltage is applied such that the positively-charged anti-reflective nanoparticles or the negatively-charged anti-reflective nanoparticles at least partially block the content according to the privacy setting.

10. The computing device of claim 8, wherein the user-specified settings include a light reduction setting and wherein the voltage is applied such that the positively-charged anti-reflective nanoparticles or the negatively-charged anti-reflective nanoparticles at least partially block ultraviolet or blue light according to the light reduction setting.

11. The computing device of claim 8, wherein the positively-charged anti-reflective nanoparticles are black nanoparticles and the negatively-charged anti-reflective nanoparticles are white nanoparticles, or wherein the positively-charged anti-reflective nanoparticles are white nanoparticles and the negatively-charged anti-reflective nanoparticles are black nanoparticles.

12. A display device, comprising:
a touch screen sensor to receive a touch input;
a display panel to display content based on the touch input, and an electrophoretic display (EPD) device between the touch screen sensor and the display panel, the EPD device to provide a voltage to at least a portion of the EPD device such, that positively-charged anti-reflective nanoparticles in the EPD device are moved toward a negative voltage and negatively-charged anti-reflective nanoparticles in the EPD device are moved toward a positive voltage, wherein the content is displayed based on locations of the positively-charged anti-reflective nanoparticles and the negatively-charged anti-reflective nanoparticles in response to the voltage, wherein the voltage is provided based on user-specified settings.

13. The display device of claim 12, wherein the user-specified settings include a privacy setting and wherein the voltage is provided such that the positively-charged anti-reflective nanoparticles or the negatively-charged anti-reflective nanoparticles at least partially block the content according to the user-specified privacy setting.

14. The display device of claim 12, wherein the user-specified settings include a brightness or contrast setting and wherein the voltage is provided such that the content is displayed based on the brightness or contrast setting.

15. The display device of claim 12, wherein the positively-charged anti-reflective nanoparticles and the negatively-charged anti-reflective nanoparticles are located between a first electrode panel and a second electrode panel of the EPD device and wherein the voltage is provided to the first electrode panel and the second electrode panel.
